(19) United States
(12) Patent Application Publication
(10) Pub. No.: US 2025/0044143 A1
(43) Pub. Date: Feb. 6, 2025

(54) SYSTEM AND METHOD FOR REMOTELY MONITORING A CONTAINED VOLUME OF LIQUID

(71) Applicant: Max FINSELBACH, Yaroomba (AU)

(72) Inventor: Max FINSELBACH, Yaroomba (AU)

(21) Appl. No.: 18/717,255

(22) PCT Filed: Dec. 7, 2022
(86) PCT No.: PCT/AU2022/051463

§ 371 Date: Jun. 6, 2024

(30) Foreign Application Priority Data
Dec. 7, 2021 (AU) 2021903950

(51) Int. Cl. G01F 23/80

(52) U.S. Cl. CPC G01F 23/802

(57) ABSTRACT

The present invention relates to a computer-implemented system and method for remotely monitoring a contained volume of liquid, including the use of one or more processors operable to receive data from one or more sensor devices or modules operable to monitor one or more attributes associated with the contained volume of liquid including at least the quantity of liquid contained, receive data from one or more third party services that provide forecast data relating to environmental conditions at a geographical region in which the contained volume of liquid is located, the environmental conditions of a type that have an effect on the one or more attributes including at least the quantity of liquid contained, generate, based upon the data from the one or more sensor devices or modules, and the forecast data received from the one or more third party services, a prediction regarding how the one or more attributes are likely to change over a period of time, and process the data from the one or more sensor devices or modules, the forecast data received from the one or more third party services, and the generated prediction, to generate a graphical user interface (GUI) including one or more user interface objects adapted to be displayed on a data communication device associated with a user wherein the one or more attributes of the contained volume of liquid including at least the quantity of the liquid contained, and the prediction relating to how the one or more attributes are likely to change over a period of time including at least the quantity of the liquid contained, are overlaid on the one or more user interface objects, thereby assisting the user to identify, substantially in real-time, an indication of the one or more attributes and the prediction regarding variation of same into the future.

### CROSS-REFERENCE TO RELATED APPLICATIONS

This application is a national stage entry of International Application No. PCT/AU2022/051463 filed on Dec. 7, 2022, which claims the benefit of priority to Australian Application No. 2021903950, filed Dec. 7, 2021, the entire disclosures of which are hereby incorporated herein by reference.

### FIELD OF THE INVENTION

The present invention relates to a system and method for remotely monitoring one or more attributes associated with a contained volume of liquid. In particular, the system and method monitors the attributes (including at least a quantity of liquid) and generates a graphical user interface (GUI) on a computing device for display to a remotely located user, the GUI indicating the attribute as well as a prediction regarding how the attribute is likely to change over a period of time according to forecast data.

### BACKGROUND OF THE INVENTION

Water is essential for day-to-day life and whilst there are natural sources of water (e.g. rivers, streams, etc) that can be accessed for the purpose of consumption, irrigation, etc, most properties will not have direct access to a natural water source and at most locations it is necessary to contain water (or transport water to the property) for storage of same. For example, most residential and rural properties in Australia utilise rain-water tanks to collect rainfall captured at the properties, with such water typically utilised to provide drinking water for pets and farm animals and to provide irrigation for gardens and farm crops. Water tanks that are not dependent upon rainfall (or at least not solely dependent) are also common, and these types of tanks may be re-filled by transporting water to the location for the specific purpose of re-filling such tanks.

Irrespective of how water is sourced (i.e. from rain or by transportation) or contained (i.e. in a river bank, reservoir or tank), there is a common requirement for certain attributes of the contained volume of liquid to be monitored. For example, it is important for the level of rivers to be monitored so that measures can be put in place to avoid natural disasters such as flooding. In another example, the level and/or quantity of water tanks located in rural properties need to be regularly monitored since if water levels become too low, there will be insufficient water for consumption, irrigation, etc. Where the rural property is reliant upon the health of animals and crops for the purpose of generating an income, insufficient water supplies may also translate into reduced income.

A problem with monitoring an attribute of a contained liquid is that traditional monitoring techniques require users to be physically present at the location of the liquid and hence, such monitoring is unable to occur when the user is located remotely or is not able to access the location for any reason. Whilst this is not a significant problem in residential settings where, for example, the liquid level in a tank can easily be monitored by human observation, this can be a significant problem in rural settings where multiple tanks are often geographically dispersed across a farm property and individual tanks may be separated by kilometres, making monitoring by observation difficult and time consuming. The requirement for human monitoring also places a significant restriction on the movements of a farmer since there needs to be at least one person on site at all times to ensure that regular monitoring is performed. There may also be situations where a farmer will simply forget to check water levels.

The use of sensors and measuring devices in water tanks to monitor liquid levels and transmit data to enable remote monitoring of the water level is known. Irrespective of whether liquid levels are measured by human observation, or by more sophisticated means (using sensors and measuring devices), the result of such monitoring relates to an instance in time and hence fails to provide the user with an indication regarding how the particular measured attribute is likely to change over time (i.e. into the future). Wind, rain, heat and other weather-related factors can have a significant impact upon the propensity for a contained liquid to evaporate or be replenished. For example, in warm weather conditions the water level in a tank is likely to reduce due to evaporation, whereas during cold weather conditions, the water level is likely to increase due to higher precipitation levels. However, weather is generally difficult to predict due to significant shifts in weather patterns over short periods of time, and in view of uncharacteristic weather that can arise when least expected (e.g. drought during winter months, and heavy downpours during summer months).

It would be beneficial for at least farmers to have the ability to check attributes such as water level or quantity of their tanks from a remote location at any time, but to also understand how that attribute (e.g. water level or quantity) is likely to behave into the future over the coming days, weeks and even months. Such knowledge would allow farmers greater flexibility and importantly freedom to leave their property with increased certainty that their tanks are unlikely to reach levels that are sufficiently low to have an adverse impact upon their property and livelihood.

The currently available technologies known to the Applicant for the purpose of monitoring and managing an attribute of a contained volume of liquid also utilise significant amounts of computer processing, memory and network resources. Accordingly, a technical problem exists regarding how computing resources may be utilised more efficiently and conserved, without compromising the quality of the ongoing monitoring and management task.

The computer-implemented system and method of the present invention seeks to address the above identified problems or at least provide an alternative solution to same.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented method for remotely monitoring a contained volume of liquid, the method including, receiving, by one or more processors, data from one or more sensor devices or modules operable to monitor one or more attributes associated with the contained volume of liquid, including at least a volume of liquid contained, receiving, by one or more processors, data from one or more third party services that provide forecast data relating to environmental conditions at a geographical region in which the contained volume of liquid is located, the environmental conditions of a type that have an effect upon the one or more attributes, including at least the volume of the contained liquid, generating, by one or more processors, based upon the data from the one or more sensor devices or modules, and the forecast data received from the one or more third party services, a prediction regarding how the one or more attributes are likely to change over a period of time, and processing, by one or more processors, the data from the one or more sensor devices or modules, the forecast data received from the one or more third party services, and the generated prediction, to generate a graphical user interface (GUI) including one or more user interface objects adapted to be displayed on a data communication device associated with a user, wherein a current indication of the one or more attributes of the contained volume of liquid including at least the current volume of the contained liquid and an estimated indication of the one or more attributes including at least the volume of the contained liquid at a particular future point in time based on the prediction relating to how the one or more attributes are likely to change over a period of time are overlaid on the one or more user interface objects, thereby assisting the user to identify, substantially in real-time, a current indication of the one or more attributes and an estimation regarding variation of same at the particular future point in time.

In an embodiment, the contained volume of liquid is a contained volume of water associated with one or more of a tank, a trap, a river, a dam, a reservoir, or similar.

In an embodiment, the one or more attributes may include an attribute other than the volume of liquid contained, e.g. a liquid level of the contained volume of liquid.

In an embodiment, the liquid is water.

In an embodiment, the one or more third party services that provide forecast data includes a third party service capable of providing reliable and accurate weather forecasting data (e.g. Amazon forecast application programming interface (API), access to data systems associated with a Bureau of Meteorology (BOM), etc), wherein the forecasting data relates to future environmental conditions including forecasted temperature, wind, and/or rain (precipitation) in the geographical region.

In an embodiment, the method further includes providing data obtained from the one or more sensor devices or modules to the one or more third party services.

In an embodiment, the one or more sensor devices or modules includes an Internet of Things (IoT) device appropriately positioned in, or adjacent, the contained liquid to capture data relating to the one or more attributes. For example, in the case of a water tank, one or more sensor devices may be fixed to an internal wall of the tank in a location to measure attributes.

In an embodiment, each sensor device or module has a rechargeable battery that is configured to be charged by solar power.

In an embodiment, the one or more processors are associated with a central server and the one or more sensor devices or modules are configured to wirelessly transmit captured data directly to the central server, or indirectly to the central server via one or more intermediate devices.

In an embodiment, the one or more intermediate devices are configured to receive and transmit data, or at least extend or enhance the signal transmitted by the one or more sensor devices or modules. For example, an intermediate device may be in the form of a modem or a transponder, including terrestrial or satellite transponders, and the intermediate device may be mounted to a vehicle such as an autonomous vehicle (e.g. drone) capable of travelling between a first location adjacent the one or more sensor devices or modules and a second location adjacent the central server.

In an embodiment, the one or more user interface objects includes one or more of, a digital display of the real-time indication of the one or more attributes (e.g. the water level displayed in centimetres or metres or feet, or the water quantity displayed in litres or gallons), a digital display of the real-time indication of the one or more attributes as compared with a predefined value for the one or more attributes (e.g. the water level as compared with the total tank height, or the water quantity as a percentage of the total capacity of the tank), a digital display of one or more current and/or future environmental conditions in the geographical region (e.g. a current and/or future precipitation forecast), a digital display of a period of time (e.g. day, week, month) and how the one or more attributes are likely to change over the period of time; and a digital display of one or more graphs of which one axis relates to time, and another axis relates to the one or more attributes (e.g. a graph of liquid level/quantity versus time).

In an embodiment, the period of time displayed on the digital display is selectable by a user (e.g. the user may select to view how the water level in a particular tank is likely to change over the next 24 hours, the next 2 days, over the next 7 days, or over the next month, etc).

In an embodiment, the one or more attributes are displayed in a two-dimensional or three-dimensional graphical representation that virtually represents the actual appearance of the physical attribute.

In an embodiment, the volume of liquid is associated with a tank, and the graphical representation is in the form of a two-dimensional or three-dimensional graphical image of the tank including a graphical indication of a volume of liquid representative of the actual volume of liquid in the tank.

In an embodiment, the method further includes, generating, by one or more processors, a notification or alert when the one or more attributes fail to satisfy a predefined requirement or threshold (eg. where a value exceeds a maximum threshold, or is below a minimum threshold), and transmitting the notification or alert to a user.

In an embodiment, the notification or alert is transmitted to the user by one or more of overlaying the notification or alert on a graphical user interface object displayed in the GUI or, alternatively/additionally, a push notification, text message or email is transmitted to a user device.

In an embodiment, the method further includes receiving, by one or more processors, user feedback data regarding the success or otherwise of different strategies with respect to management of the contained volume of liquid (e.g. whether a particular type of tank lasts longer than another, whether causing a tank to be re-filled at a particular time of year, or to be located in a particular geographical region, results in additional benefits as compared with other times of year or regions, etc).

In an embodiment, the method further includes storing, in one or more databases, data captured by the one or more sensor devices or modules, the data from the one or more third party services, and any feedback data, thereby enabling development of a database of data for training a machine learning model.

In an embodiment, the method further includes generating, using the trained machine learning model, recommendations regarding future management strategies with respect to the contained volume of liquid, the machine learning model trained over time using the stored data including feedback data relating to the success or otherwise associated with different management strategies (eg. purchase of particular types of tanks, placement of tanks in particular locations, and re-filing of tanks at particular times of year).

In a second aspect, the present invention provides a system for remotely monitoring a contained volume of liquid, the system including one or more processors operable to receive data from one or more sensor devices or modules operable to monitor one or more attributes associated with the contained volume of liquid including at least the volume of liquid contained, receive data from one or more third party services that provide forecast data relating to environmental conditions at a geographical region in which the contained volume of liquid is located, the environmental conditions of a type that have an effect on the one or more attributes including at least the quantity of liquid contained, generate, based upon the data from the one or more sensor devices or modules, and the forecast data received from the one or more third party services, a prediction regarding how the one or more attributes are likely to change over a period of time, and process the data from the one or more sensor devices or modules, the forecast data received from the one or more third party services, and the generated prediction, to generate a graphical user interface (GUI) including one or more user interface objects adapted to be displayed on a data communication device associated with a user wherein a current indication of the one or more attributes of the contained volume of liquid including at least the current volume of the contained liquid, and an estimated indication of the one or more attributes including at least the volume of the contained liquid at a particular future point in time based on the prediction relating to how the one or more attributes are likely to change over a period of time, are overlaid on the one or more user interface objects, thereby assisting the user to identify, substantially in real-time, a current indication of the one or more attributes and an estimation regarding variation of same into the particular future point in time.

In a third aspect, the present invention provides a computer-readable medium having a plurality of instructions executable by one or more processors to, receive data from one or more sensor devices or modules operable to monitor one or more attributes associated with the contained volume of liquid including at least a volume of liquid contained, receive data from one or more third party services that provide forecast data relating to environmental conditions at a geographical region in which the contained volume of liquid is located, the environmental conditions of a type that have an effect on the one or more attributes, including at least the quantity of liquid contained, generate, based upon the data from the one or more sensor devices or modules, and the forecast data received from the one or more third party services, the prediction regarding how the one or more attributes are likely to change over a period of time, and process the data from the one or more sensor devices or modules, the forecast data received from the one or more third party services, and the generated prediction, to generate a graphical user interface (GUI) including one or more user interface objects adapted to be displayed on a data communication device associated with a user wherein a current indication of the one or more attributes of the contained volume of liquid including at least the current volume of the contained liquid and an estimated indication of the one or more attributes including at least the volume of the contained liquid at a particular future point in time based on the prediction relating to how the one or more attributes are likely to change over a period of time are overlaid on the one or more user interface objects, thereby assisting the user to identify, substantially in real-time, a current indication of the one or more attributes and an estimation regarding variation of same at the particular future point in time.

### BRIEF DESCRIPTION OF THE DRAWINGS

Features of the present disclosure are illustrated by way of example and not limited in the following Figure(s), in which like numerals indicate like elements, in which:

FIG. 1 provides an overview of a system according to an embodiment of the present invention showing, in particular, the interaction of various system components;

FIG. 2 illustrates an exemplary diagram associated with the server component within the system illustrated in FIG. 1;

FIG. 3 illustrates an exemplary flow diagram of the server component of FIG. 2 including an internet gateway device configured to communicate with one or more sensors associated with a volume of liquid contained inside a tank;

FIG. 4 illustrates an exemplary flow diagram of the server component of FIG. 2 communicating with one or more intermediary devices used to extend or enhance the signal transmitted by the one or more sensor devices shown in FIG. 3;

FIG. 5 illustrates an exemplary flow diagram of a process that enables a user to download and install a software application, and subsequently access, or registered to use, the software application for interaction with the system illustrated in FIG. 1;

FIG. 6 illustrates an exemplary flow diagram of a process that enables the user to utilise the software application to view one or more attributes of the contained volume of liquid and a prediction relating to how the one or more attributes are likely to change over a period of time; and

FIG. 7 illustrates an exemplary flow diagram of the server component of FIG. 2 communicating with one or more third party services for the purpose of collecting forecast data relating to environmental conditions at the geographical region in which the contained volume of liquid is located and which may have an effect on the one or more attributes of the contained volume of liquid.

### DETAILED DESCRIPTION OF EMBODIMENT(S) OF THE INVENTION

For simplicity and illustrative purposes, the present disclosure is described by referring to embodiment(s) thereof. In the following description, numerous specific details are set forth in order to provide a thorough understanding of the disclosure. It will be readily apparent, however, that the current disclosure may be practised without limitation to the specific details disclosed herein. In other instances, some methods and structures have not been described in detail to avoid obscuring the disclosure.

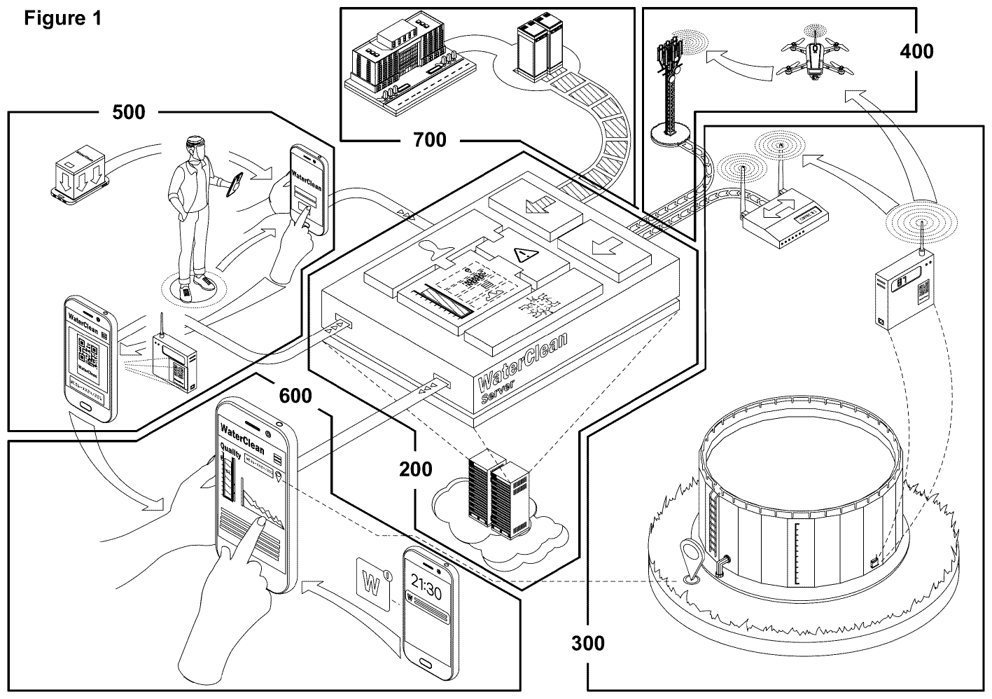

In an embodiment, the present invention provides a system and method for remotely monitoring a contained volume of liquid including, at least, the quantity of the contained volume of liquid with the major system components as depicted in FIG. 1. In the embodiment shown in the accompanying Figures, the contained body of liquid is a tank (60). However, it is to be understood that the contained volume of liquid may be in the form of any other type of enclosure or partial enclosure including a trap, river, dam, reservoir or storage vessel that contains a quantity of water (or other liquid). The embodiment of the system and method described provide a platform that hosts a computer-executable software application (40), wherein the application (40) is accessible by a plurality of users (30) who prefer to monitor attributes associated with contained volumes of liquid (e.g. one or more tanks on a farm owned by the user (30)). The platform enables the generation of a display (340) of one or more attributes (eg. liquid level or quantity of liquid) of the contained volume of liquid (60) and a prediction regarding how the one or more attributes are likely to change over a period of time (eg. a forecast), thereby assisting the user (30) to obtain, substantially in real-time, an indication of the one or more attributes and the prediction regarding variation of same into the future.

The central server (20) maintains one or more processors and/or databases for performing functions, including receiving (170) data from one or more sensor devices or modules (70) operable to monitor one or more attributes associated with the contained volume of liquid (60) and receiving (180) data from one or more third party services (80) that provide forecasted data relating to environmental conditions of a geographical region in which the contained volume of liquid (60) is located (74) and the environmental conditions of a type that have an effect on the one or more attributes and more particularly, the volume of the contained liquid.

Based upon the data from the one or more sensor devices or modules (70) and forecast data received from the one or more third party services (80), the server (20) may then generate a prediction regarding how the one or more attributes are likely to change over a period of time, and further generate a graphical user interface (340) including one or more user interface objects (eg. tables, graphs, etc.) adapted to be displayed on a device (50) associated with the user (30). In this regard, the one or more attributes of the contained volume of liquid (60) and the prediction regarding how the attributes are likely to change over a period of time may be overlaid on the one or more user interface objects, thereby assisting the user (30) to identify the one or more attributes and the prediction at any moment in time.

The skilled reader will appreciate that the platform provides a solution that allows for the simplified monitoring and analysis of attributes such as water levels associated with a contained volume of liquid (60) through a mobile application (40) operating on a user device (50). The application (40) displays the real-time, or near real-time, water levels (and/or other attributes of the liquid) and provides intelligent predictive analysis to alert the user (30) to situations where attributes such as water supplies may be reaching particular thresholds, or are likely to reach particular thresholds, in the future (eg. where water levels are reaching a minimum or where water supplies are likely to be exhausted in the future).

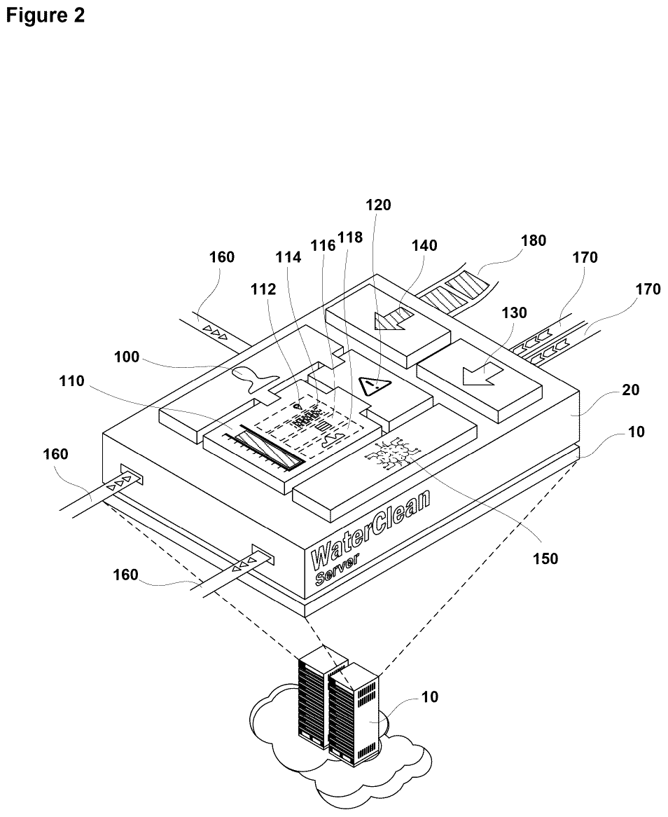

FIG. 1 is divided into segments which are further expanded in subsequent FIGS. 2 to 7. In particular Segment 200 of FIG. 1 depicts the server component (20) in respect of which the software application (40) operating on data communication devices (50) of users (30) are configured to communicate. It will be apparent to the skilled reader that the software application (40) may be a mobile application or a web application, and similarly, the data communication device (50) associated with each user (30) may be a mobile device or a fixed location computing device. Examples of mobile devices include mobile phones or computer tablets, and examples of fixed location computing devices include workstations or personal computers.

The server component is further detailed in FIG. 2 and the skilled reader will appreciate that the steps described herein, as executable by the devices (50), may be facilitated by the software application (40) operating on each device (50).

As an alternative, or in addition to, steps described herein as performed by the server (20), the steps described may be performed by one or more processors associated with the user devices (50) (i.e. in a distributed architecture). Different arrangements are possible in this regard, but according to a particular implementation of the present invention, the server (20) is programmed to provide all of the functions provided herein where they cannot be provided locally on the user devices (50) or where it may be impractical to do so.

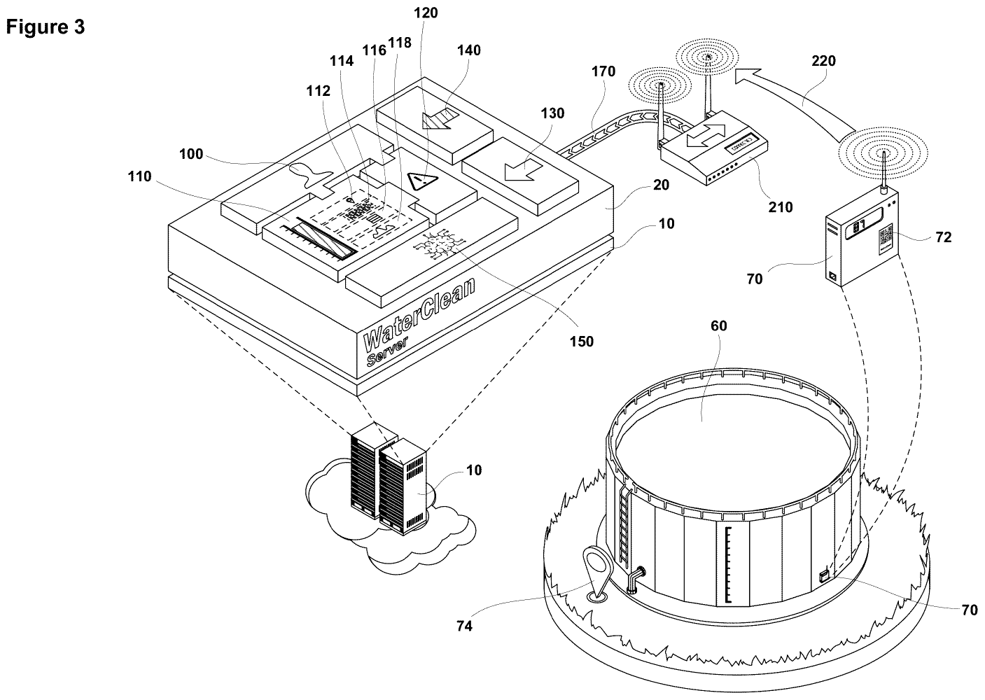

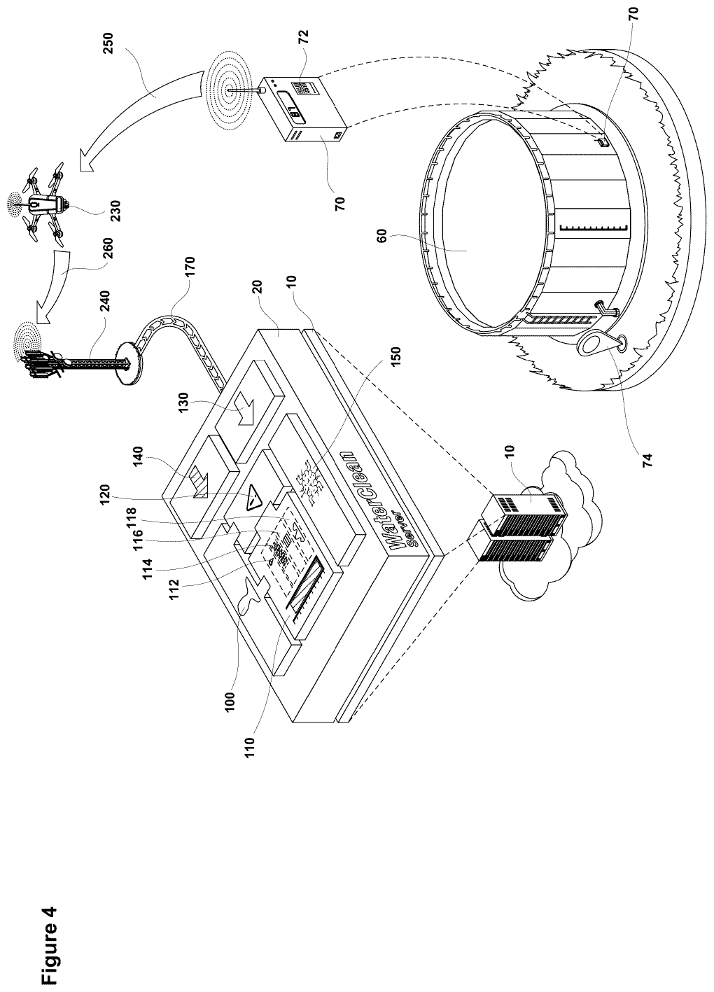

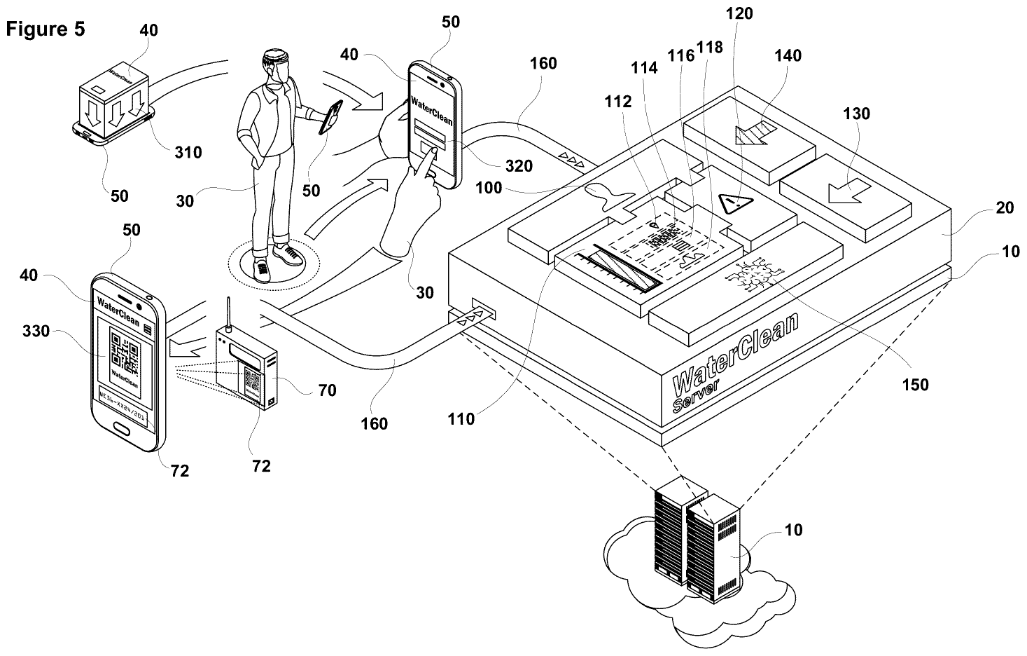

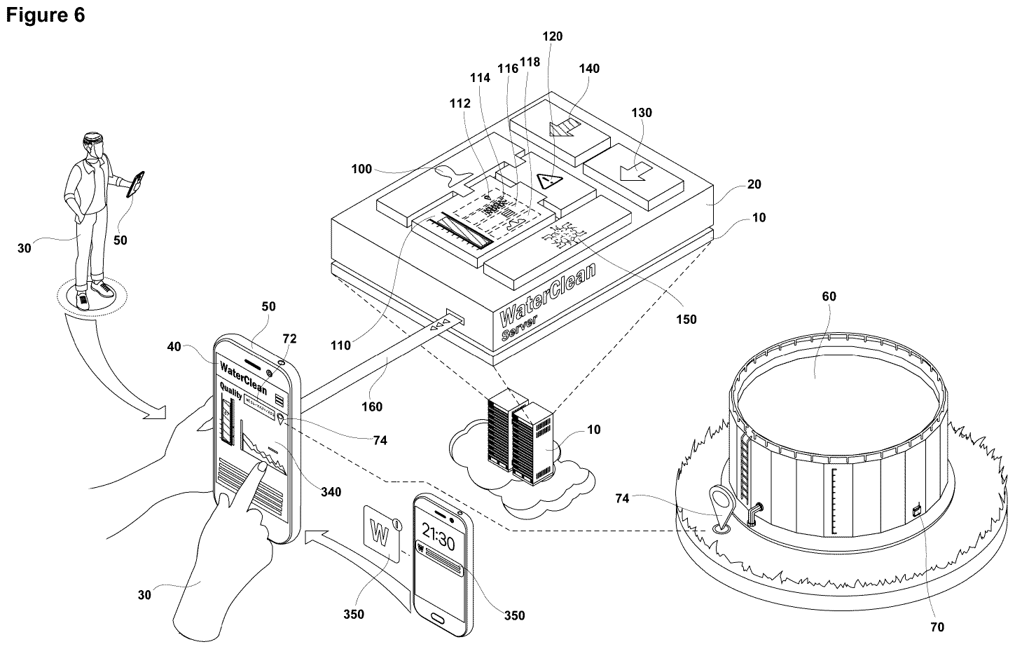

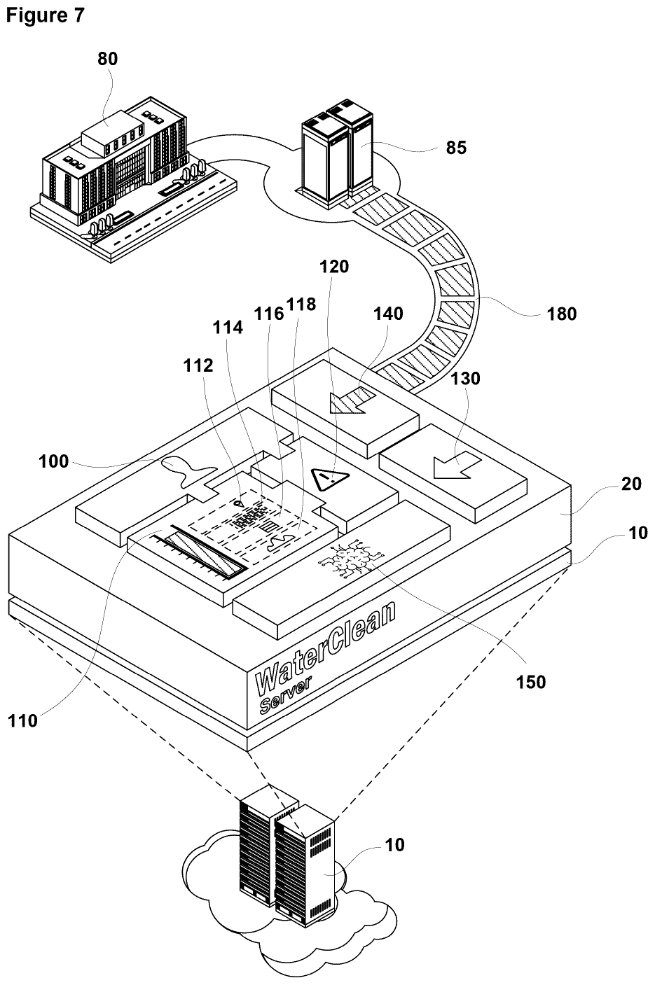

Segment 300 of FIG. 1 depicts an example of how the server (20) may be configured for communication (170) with the one or more sensor devices or modules (70) associated with the contained volume of liquid (60), which is further detailed in FIG. 3. Segment 400 of FIG. 1 depicts how the server (20) may also be configured for communication (180) with one or more intermediary devices (230, 240) which may be used to extend or enhance the signal transmitted by the one or more sensor devices or modules (70), as further detailed in FIG. 4. Segment 500 of FIG. 1 shows a user (30) downloading and installing the software application and subsequently registering the one or more sensors or modules (70) to associate the sensors or modules (70) with an account established for the user, as further detailed in FIG. 5. Segment 600 of FIG. 1 illustrates how the user (30) may utilise the application (40) to view the one or more attributes of the contained volume of liquid (60) in addition to a prediction regarding how the one or more attributes are likely to change over a period of time, as further detailed in FIG. 6. Finally, Segment 700 of FIG. 1 illustrates how the server (20) may be configured for communication (180) with the one or more third party services (80) for retrieving forecast data, as detailed in FIG. 7.

As mentioned above, FIG. 2 shows in greater detail the Segment (200) of FIG. 1, and in particular, FIG. 2 shows the server component (20) which includes infrastructure (10) upon which the platform of the present invention may operate. The infrastructure may be local or cloud-based. The central server (20) may operate one or more computer processors and maintain one or more databases to enable the following functionality and/or storage:
User account register (100) storing details of users (30) who are registered to use the software application (40) (eg. name, address, contact details, and any additional data which may be relevant for the purpose of identifying each user). Where possible, these details may be verified using identification verification services;
Sensor or module register (110) storing details relating to each sensor device or module (70) registered with the application (40) by users (30), (eg. water level sensors, water quantity sensors, etc). The register (110) may further store unique identification details (72) associated with each sensor device or module (70), (eg. unique sensor serial number or code that identifies a particular sensor, which may be printed on the sensor as a number or as a QR code for easy capture and entry), and the identification details may be linked to particular user accounts stored in register (100);
Sensor location data (112) storing data relating to the geographical location (74) of each registered sensor device or module (70);
Senor attribute data (114) storing data relating to the one or more attributes that have been captured by the one or more sensor devices or modules (70) (eg. historical data relating to the water/liquid level in the contained volume of liquid (60) as captured by the sensor device(s) (70));
Current attribute data (116) storing real-time data relating to one or more attributes captured by the sensor devices or modules (70) (eg. the current water/liquid level in the storage tank (60));
Prediction data (118) storing data relating to predictions generated by the server (20) in relation to how the one or more attributes are likely to change over a period of time in the future;
Threshold data (120) storing details relating to certain thresholds which give rise to alerts or notifications to be generated and provided to users (30) (eg. thresholds relating to notifiable events including water volume below or above a threshold level, higher than expected consumption of liquid which may indicate a leak or theft, or where the prediction data (118) indicates that a certain attribute will be below a threshold within a predetermined period of time into the future;
Sensor data collection (130) including functionality that receives and validates data from the one or more sensor devices or modules (70), and subsequently based upon an acceptable validation, stores same in database (114) and/or (116);
Forecast data collection (140) including functionality that enables the server (20) to receive and collect forecast data from the one or more third party forecasting services (80) which, as shown in FIG. 7, may include data systems (85) used by the providers (80) to store data such as weather and other forecasts (eg. river levels and other environmental observations captured by a bureau of meteorology);
Predictive analysis functionality (150) which enables the processing of the data from the one or more sensor devices or modules (70) together with the forecast data (118) received from the one or more third party services (80) in order to generate the graphical user interface (340) which indicates a current status of the one or more attributes as well as a forecast with respect to the one or more attributes (ie. how the one or more attributes is likely to change over a period of time). Additional data may be processed by the intelligent predictive analysis functionality (150), namely, data received in addition to the data from the sensors and the forecast data (eg. data relating to the storage location (74), historical usage data, and various other data inputs as may be appropriate for the purpose of generating a more accurate prediction, thereby assisting the user (30) in their water management).

FIG. 2 also depicts that server (20) is configured to enable communication (160) with the devices (50) and in particular, the software application (40) operating on each device (50). FIGS. 2 to 4 also show how server (20) is configured to communicate (170) with the one or more sensor devices or modules (70), and/or the intermediate devices (230, 240). FIGS. 2 and 7 further depict how server (20) is configured to communicate (180) with the forecasting services (180) and, in particular, the forecasting service data system (85). Such communication may occur via the internet or similar network.

FIG. 3 shows in greater detail Segment 300 of FIG. 1 and, in particular, the use by user (30) of an internet gateway device (210), which may be in the form of a router or similar device with a connection to the internet to facilitate the communication (170) between the one or more sensor devices or modules (70) and the central server (120). For example, the one or more sensor devices or modules (70) may utilise Wi-Fi, fixed wire, satellite or other connection (220) between the device or module (70) and the internet gateway device (210). By transmitting data in this way, the server (20) can effectively measure an attribute of tank (60) (eg. the liquid volume of the tank), and then utilise such data for the purpose of presenting useful information to the user (30), as described in greater detail below.

The one or more sensor devices or modules (70) may include internet of things (IoT devices) appropriately positioned in the vicinity of the contained liquid to capture data relating to the one or more attributes. For example, in the case of a water tank (60), the sensor device (70) may be configured to measure the liquid volume of the tank (60). However, it is to be understood that different sensors and/or modules may be used to measure different attributes, and the selection of particular sensors and/or modules will depend upon the particular application.

The sensor device (70) as shown in FIG. 3 is attached to the storage vessel (60) and captures the liquid/water volume. Depending on the nature and location of the storage vessel, more than one sensor may be required. Typically, the sensors will be powered by one or a combination of mains power, battery or solar, and as described earlier, each sensor may be uniquely identified (72) so that the server (20) can associate a particular sensor device or module (70) with a particular user (30).

Each device or module (70) may be programmed to capture and store data (eg. continuously or at predetermined intervals). The rate of data capture may, for example, be based upon a predetermined number of minutes or hours (eg. the capture of sensor data may take place every 24 hours (daily)). The device (70) will then transmit the data to the server (20), as shown in FIG. 3, as soon as a connection to the server (20) is established. In the event data cannot be transferred immediately it may be stored until a connection becomes available, wherein the failure to receive timely data transmission may cause intermediate devices to be automatically activated (such as one or more drones launched automatically to travel toward the device transmission zone) to effect a data transition from the one or more sensors.

FIG. 4 shows in greater detail Segment 400 of FIG. 1 and, in particular, a circumstance in which an internet gateway device (210) may not be available or is positioned too far from the sensor device to enable the transfer of data from the sensor device (70) to the internet gateway device (210). In this scenario, the one or more sensor devices or modules (70) may be configured to wirelessly transfer captured data indirectly to the server (20), or an associated internet gateway device (not shown in FIG. 4), via one or more intermediary devices (230, 240) operable to receive and transmit data or at least extend or enhance the signal transmitted by the one or more sensor devices or modules (70). FIG. 4 shows an example of a drone or similar unmanned vehicle (230) configured to fly over, or sufficiently near, the liquid storage tank (360) to communicate with the one or more sensor devices or modules (70) for the purpose of collecting data from the device (70) on a regular basis, and whereby the drone (230) is programmed to transmit collected data to a base station or communications tower (240) capable of receiving the data from the drone (230) and which has a connection to the internet or similar to facilitate the transmission of such data to the server (20) or an associated device. In a farm, for example, drones or similar autonomous vehicles may be used to travel between multiple different water tanks (60) associated with the particular farm for the purpose of collecting (250) data from the one or more sensor devices or modules (70) and returning to upload (260) such data to the communications tower (240), or to the server (20) or device associated with the server (20).

FIG. 5 shows in greater detail Segment 500 of FIG. 1, and in particular, the steps associated with a user (30) (eg. a farmer) installing (310) the software application (40) on their device, and subsequently accessing a user login and registration interface (320) associated with the application (40). Such access may be granted after the user (30) has installed the application (40) which may be achieved by downloading the application (40) from an application store. Each user (30) may create an account using the application (40) and the account information may be stored in the user account register (100).

As described above, the user account register (100) may capture information sufficient to enable each user (30) to be correctly identified.

Once the application (40) has been accessed by the user (30), the user (30) may be presented with an interface (330) that allows the user (30) to associate one or more sensor devices or modules (70) with their user account (100). For example, this may be achieved by the user (30) entering a unique sensor serial number (72) via a device keypad or by scanning a QR code on the sensor device or module (70). Additional information relating to each sensor may be captured in this process, including the GPS co-ordinates of the sensor and the particular attributes that the sensor is capable of capturing with respect to the contained volume of liquid (60).

FIG. 6 shows in greater detail elements of Segment 600 of FIG. 1 and, in particular, use of the software application (40) by the user (30) to view, in an interface (340), the captured one or more attributes of the contained volume of liquid (60) and the prediction regarding how the one or more attributes are likely to change over a period of time, thereby enabling the user to receive, substantially in real-time, an indication of the one or more attributes and the prediction. In one example, the forecast data received from the forecasting servers (80) (eg. Bureau of Meteorology, or Amazon forecast application programming interface (API)) relates to future environmental conditions including forecasted temperature, wind and rain (precipitation) at the particular location (74) or in the geographical region associated with the location (74), as well as data relating to how such conditions are likely to change over a period of time (eg. over the course of a day, night, 24-hour period, week, month etc.).

In this example, where the sensor device (70) captures water volume, level and/or quantity, it will be appreciated that the interface (340), following processing of such data by the intelligent predictive analysis functionality (150), may provide a real-time indication of the one or more attributes. This may include the water level displayed in centimetres or metres (or feet), or the water quantity displayed in litres (or gallons). The display of the real-time indication of the one or more attributes may also provide a comparison with a pre-defined value (eg. the water level as compared with the total tank height, or water quantity as a percentage of the total capacity of the tank). Additional displayed attributes may include or one or more current or future environmental conditions in the geographical region (eg. a current and or future precipitation forecast), and/or a display of a period of time (eg. day, week, month) and how the one or more attributes are likely to change over the period of time. Such information may be overlaid onto one or more tables or graphs, such as the examples depicted in interface (340) in FIG. 6. For example, a graph may include one axis relating to time, and another axis relating to the captured one or more attributes (eg. a graph of liquid level/quantity versus time).

The interface (340) may also include filters to enable the user (30) to filter the results or focus on particular results. For example, the user (30) may select to view how the water level in a particular tank is predicted to change over the next 24 hours, the next two days, the next seven days, or over the next month, etc.). The interface (340) may further depict the one or more attributes in a graphical representation that represents the appearance of a physical attribute (eg. a 2-D, or 3-D depiction of a tank (60)) with a representation of the contained liquid representing the level of liquid in the tank at the particular point in time, and at any particular future point in time.

FIG. 6 further illustrates an alerts/notifications interface (350) for issuing alerts/notifications to users (30). For example, when the server (20) and processors capture data and determine that one or more attributes no longer satisfy a minimum threshold (eg. where a particular value exceeds a maximum threshold or is below a minimum threshold), the user (30) may be notified regarding same. A typical scenario in which such an alert may be generated is where the water level, or water quantity, within the tank (60) is detected under a minimum threshold, or it is detected that the threshold will not be satisfied at a particular point in time in the future (eg. in seven days). In this way, the information provided in interface (340) and the alert notifications provided by interface (350) assist the user (30) to understand the activity inside the water tank (60) and thereby enables the user (30) to take appropriate action, including scheduling an appropriate action in the future, and to generally assist the user (30) with respect to their water management.

The interface (350) may also provide alerts and/or notifications with respect to faults (eg. when it is detected that data is no longer transmitted by one or more sensor devices (70)) and the software application (40) may be used to troubleshoot the faults and enable the user (30) to take appropriate corrective action.

It will be appreciated that by providing the user (30) with a forecast regarding how the liquid in the contained vessel is likely to behave over a future period of time, the user (30) can more easily manage their liquid storage and reduce instances of liquid reaching dangerously low levels, for example. Users (30) can establish alerts such that they are notified of particular events (eg. when water volume or level reaches below or above a certain threshold, where the consumption of liquid is higher than expected which may indicate a leak or theft, or where the “number of days remaining” in relation to accessible liquid falls below a threshold). Such alerts and notifications can be sent to the user (30) in one or more of the interfaces generated by the software application (40), by push notification, text message or email.

The software application (40) may also enable the user to provide user feedback data regarding the success, or otherwise, of different strategies with respect to management of the contained volume of liquid (60) (eg. where a particular type or brand of tank lasts longer than another, or whether causing a tank to be re-filled at a particular time in the year, or to be located in a particular geographical region, results in additional benefits as compared with alternatives). In this regard, the server (20) may store the data captured by the one or more sensor devices or modules (70), as well as the forecasted data from the one or more third party services (80), and any feedback data from the user (30), to develop a database of useful data for subsequent analysis. For example, a machine learning model may be trained utilising such data to generate recommendations regarding future management strategies with respect to the contained volume of liquid (60). The machine learning model may be trained over time using such data, and therefore over time, the recommendations provided by the model will become more accurate and thereby more helpful to the user (30).

As used herein, the term “server”, “system”, “computer”, “computing system” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms.

The one or more processors as described herein are configured to execute a set of instructions that are stored in one or more data storage units or elements (such as one or more memories), in order to process data. For example, the one or more processors may include or be coupled to one or more memories. The data storage units may also store data or other information as desired or needed. The data storage units may be in the form of an information source or a physical memory element within a processing machine.

The set of instructions may include various commands that instruct the one or more processors to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein illustrate one or more control or processing units. It is to be understood that the processing or control units may represent circuits, circuitry, or portions thereof that may be implemented as hardware with associated instructions (eg. software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like.

Optionally, the one or more processors may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in the figures or a described method.

Throughout this specification and claims which follow, unless the context requires otherwise, the word “comprise”, and variations such as “comprises” and “comprising”, will be understood to mean the inclusion of a stated feature or step, or group of features or steps, but not the exclusion of any other feature or step, or group of features or steps.

The reference to any prior art in this specification is not, and should not be taken as, an acknowledgement or any suggestion that the prior art forms part of the common general knowledge.

1. A computer-implemented method for remotely monitoring a contained volume of liquid, the method comprising:
receiving, by one or more processors, data from one or more sensor devices or modules operable to monitor one or more attributes associated with the contained volume of liquid, comprising at least a volume of liquid contained;
receiving, by one or more processors, data from one or more third party services that provide forecast data relating to environmental conditions at a geographical region in which the contained volume of liquid is located, the environmental conditions of a type that have an effect upon the one or more attributes comprising at least the volume of the contained liquid;
generating, by one or more processors, based upon the data from the one or more sensor devices or modules, and the forecast data received from the one or more third party services, a prediction regarding how the one or more attributes are likely to change over a period of time; and
processing, by one or more processors, the data from the one or more sensor devices or modules, the forecast data received from the one or more third party services, and the generated prediction, to generate a graphical user interface (GUI) comprising one or more user interface objects adapted to be displayed on a data communication device associated with a user,
wherein a current indication of the one or more attributes of the contained volume of liquid, comprising at least the current volume of the contained liquid, and an estimated indication of the one or more attributes comprising at least the volume of the contained liquid at a particular future point in time based on the prediction relating to how the one or more attributes are likely to change over a period of time, are overlaid on the one or more user interface objects, thereby assisting the user to identify, substantially in real-time, a current indication of the one or more attributes and an estimation regarding variation of same at the particular future point in time.

2. The method of claim 1, wherein the contained volume of liquid is a contained volume of water associated with one or more of:
a tank,
a trap,
a river,
a dam, or
a reservoir.

3. The method of either claim 1, wherein the one or more attributes further comprise a level of the contained volume of liquid.

4. A The method of claim 1, wherein the one or more third party services that provide forecast data comprises a third party service capable of providing weather forecasting data, wherein the forecasting data relates to future environmental conditions comprising forecasted temperature, wind, and/or rain in the geographical region.

5. (canceled)

6. A The method of claim 1, wherein the one or more sensor devices or modules comprises an Internet of Things (IoT) device appropriately positioned in, or adjacent, the contained liquid to capture data relating to the one or more attributes.

7. The method of claim 6, wherein the contained volume of liquid is associated with a water tank, and the one or more sensor devices are fixed to an internal wall of the tank in a location to measure the one or more attributes.

8. A The method of claim 6, wherein each sensor device or module has a rechargeable battery that is configured to be charged by solar power.

9. The method of claim 6, wherein the one or more processors are associated with a central server and the one or more sensor devices or modules are configured to wirelessly transmit captured data directly to the central server, or indirectly to the central server via one or more intermediate devices.

10. The method of claim 9, wherein the one or more intermediate devices are configured to receive and transmit data, or at least extend or enhance the signal transmitted by the one or more sensor devices or modules.

11. A The method of claim 10, wherein the one or more intermediate devices comprise one or more of:
a modem;
a terrestrial transponder; or
a satellite transponder.

12. The method of claim 11, wherein the intermediate device is mounted to an autonomous vehicle capable of travelling between a first location adjacent the one or more sensor devices or modules and a second location adjacent the central server.

13. A The method of claim 11, wherein the one or more user interface objects comprises one or more of:
a digital display of the real-time indication of the one or more attributes as compared with a predefined value for the one or more attributes,
a digital display of one or more current and/or future environmental conditions in the geographical region, and
a digital display of one or more graphs of which one axis relates to time, and another axis relates to the one or more attributes.

14. The method of claim 1, wherein the period of time displayed in the digital display is selectable by a user.

15. The method of claim 1, wherein the one or more attributes are displayed in a two-dimensional or three-dimensional graphical representation that represents the actual appearance of the physical attribute.

16. The method of claim 15, wherein the volume of liquid is associated with a tank, and the graphical representation is in the form of a two-dimensional or three-dimensional graphical image of the tank comprising a graphical indication of a volume of liquid representative of the actual volume of liquid in the tank.

17. The method of claim 1, wherein the method further comprises, generating, by one or more processors, a notification or alert when the one or more attributes fail to satisfy a predefined requirement or threshold, and transmitting the notification or alert to a user by one or more of overlaying the notification or alert on a graphical user interface object displayed in the GUI or alternatively and/or additionally, a push notification, text message, or email to a user device.

18. (canceled)

19. The method of claim 1, further comprising:
storing, in one or more databases, data captured by the one or more sensor devices or modules, the data from the one or more third party services, and feedback data regarding the success or otherwise of different strategies with respect to management of the contained volume of liquid, thereby enabling development of a database of data for training a machine learning model.

20. The method of claim 19, further comprising:
generating, using the trained machine learning model, recommendations regarding future management strategies with respect to the contained volume of liquid, the machine learning model trained over time using the stored data comprising feedback data relating to the success or otherwise associated with different management strategies.

21. A system for remotely monitoring a contained volume of liquid, the system comprising:
one or more processors operable to:
receive data from one or more sensor devices or modules operable to monitor one or more attributes associated with the contained volume of liquid, comprising at least a volume of liquid contained;
receive data from one or more third party services that provide forecast data relating to environmental conditions at a geographical region in which the contained volume of liquid is located, the environmental conditions of a type that have an effect upon the one or more attributes comprising at least the volume of the contained liquid;
generate, based upon the data from the one or more sensor devices or modules, and the forecast data received from the one or more third party services, a prediction regarding how the one or more attributes are likely to change over a period of time; and
process the data from the one or more sensor devices or modules, the forecast data received from the one or more third party services, and the generated prediction, to generate a graphical user interface (GUI) comprising one or more user interface objects adapted to be displayed on a data communication device associated with a user,
wherein a current indication of the one or more attributes of the contained volume of liquid, comprising at least the current volume of the contained liquid, and an estimated indication of the one or more attributes comprising at least the volume of the contained liquid at a particular future point in time based on the prediction relating to how the one or more attributes are likely to change over a period of time, are overlaid on the one or more user interface objects, thereby assisting the user to identify, substantially in real-time, a current indication of the one or more attributes and an estimation regarding variation of same at the particular future point in time.

22. A non-transitory computer-readable medium having a plurality of instructions executable by one or more processors to:
receive data from one or more sensor devices or modules operable to monitor one or more attributes associated with the contained volume of liquid, comprising at least a volume of liquid contained;
receive data from one or more third party services that provide forecast data relating to environmental conditions at a geographical region in which the contained volume of liquid is located, the environmental conditions of a type that have an effect upon the one or more attributes comprising at least the volume of the contained liquid;
generate, based upon the data from the one or more sensor devices or modules, and the forecast data received from the one or more third party services, a prediction regarding how the one or more attributes are likely to change over a period of time; and
process the data from the one or more sensor devices or modules, the forecast data received from the one or more third party services, and the generated prediction, to generate a graphical user interface (GUI) comprising one or more user interface objects adapted to be displayed on a data communication device associated with a user,
wherein a current indication of the one or more attributes of the contained volume of liquid, comprising at least the current volume of the contained liquid, and an estimated indication of the one or more attributes comprising at least the volume of the contained liquid at a particular future point in time based on the prediction relating to how the one or more attributes are likely to change over a period of time, are overlaid on the one or more user interface objects, thereby assisting the user to identify, substantially in real-time, an indication of the one or more attributes and an estimation regarding variation of same at the particular future point in time.
